(19) United States
(12) Patent Application Publication
(10) Pub. No.: US 2002/0136805 A1
(43) Pub. Date: Sep. 26, 2002

(54) Multi-compartment rehydrating container

(76) Inventor: Colin Marshall, Wigton (GB)

Correspondence Address: WENDEROTH, LIND & PONACK, L.L.P., 2033 K STREET N. W., SUITE 800, WASHINGTON, DC, 20006-1021, US

(21) Appl. No.: 10/150,102

(22) Filed: May 20, 2002

Related U.S. Application Data
(63) Continuation of application No. 09/381,177, filed on Dec. 29, 1999.

(30) Foreign Application Priority Data
Mar. 17, 1997 (GB) 9705455.5

(51) Int. Cl. A23B 4/00

(52) U.S. Cl. 426/112

(57) ABSTRACT

There is disclosed a new self-rehydrating container for the production of solutions or suspensions substantially free or undesirable micro-organisms. The container is divided into at least two compartments by at least a non-permanent seal bonding the opposite walls of said container, the walls of the container surrounding at least a first compartment being watertight, the walls of the container surrounding at least one portion of at least a second compartment being semi-permeable, a water soluble or suspendible product or a concentrated solution or suspension thereof being retained in said second compartment and a water soluble or suspendible product, a drug, a nutritional suspension or powder to be put into solution or suspension is retained in said first compartment. This new self-rehydrating container allows the production of pure solutions of very low molecular weight solutes, of accurately dosed solutions, prevents the oxidation or hydrolysis of the material to be rehydrated and prevents the contamination of the rehydrated material by eventual residual bacteria.

This is a continuation of application Ser. No. 09/381,177, filed Sep. 17, 1999, now abandoned.

### FIELD OF THE INVENTION.

The invention is related to a new self-rehydrating container having at least two separated compartments containing solutes, drugs, insoluble materials or mixtures thereof. The invention concerns also methods of using such a container to prepare rehydrated solutions or suspensions.

### BACKGROUND OF THE INVENTION AND STATE OF THE ART

Cellulose films are known to be relatively inert semi-permeable strong membranes capable of separating compounds with different molecular weight by osmosis or dialysis for example. According to EP 360,612 or U.S. Pat. No. 4,920,105, such films are efficiently used as membrane for the manufacture of self-rehydrating container wherein the membrane constitutes at least a portion of the walls of the container and wherein an osmotically active solute is retained within the container. When this container is placed into water, osmosis takes place and fills it with water which is purified by filtration through the membrane.

In the present specification, osmotically active solute means a substantially water-soluble solute or a concentrated solution thereof able to sustain osmosis through the semi-permeable membrane.

Now, it is also possible to produce a container having a membrane comprising a thick strong layer with relatively high pores diameter and number as a support for a relatively thin layer in order to minimise—by lowering the molecular weight cut-off of the overall membrane—the unfavourable effect of dialysis on osmosis, as disclosed in our copending patent application. Despite the huge improvement achieved with such a multilayer membrane, the phenomenon of dialysis still remains present and materials with very low molecular weight can still pass throughout the membrane.

In certain applications though, protection of very low molecular weight components (sodium and potassium chloride, mineral components of milk powders or low molecular weight water soluble vitamins for example), is required.

In other applications such as oral rehydration solutions (ORS), solutions for medical use or drug suspension or solution for example, the final solute concentration must be extremely precise. Loss of solute through dialysis can therefore not be accepted. Because the extent of dialysis depends on contact time, temperature, volume of the contact fluid, etc. and cannot be accurately predicted, it is not a practical solution to incorporate a definite excess of solute to oppose the dialysis effect.

In addition, vitamins and minerals in food and beverage products or in medical solutions require protection against oxidation and/or hydrolysis. Therefore, the storage of these labile materials in a separate pouch which can be easily opened just before consumption is essential and is a fundamental part of this invention.

Another problem resides in the fact that when containers having semi-permeable membranes are used to produce nutritional solute solutions such as milk powder solutions or fruit juice preparations, the dried food may contain residual bacteria, usually in a dormant form. When the container is put into water of about 30° C., such as in tropical areas, and the rehydrated solution is consumed directly after preparation, no significant bacterial problem arises. However, if the container is left in the 30° C. water after preparation, the contaminating bacteria can proliferate and become a serious threat to health. Therefore the storage of these milk powders, dried food or fruit juice or other preparations in dry form, likely to contain residual bacteria in a separate pouch which can be easily opened and which would only be opened just before consumption when the container is already substantially full of purified water, would be of interest.

The use of a container provided with additional watertight pouches containing water-soluble solute, additional solute, liquids, drug, insoluble material, etc. is known from EP 360,612. The pouch content is released into the purified water obtained in the container once it has been removed from the external water. FIG. 3 of EP 360,612 discloses a container provided with two burstable internal pouches containing a water soluble solute. This disclosure does not enable any other embodiment of a container with an additional pouch, nor does it suggest any.

Such a pouch floating within the container is not very efficient. It necessitates a lot of supplementary steps for its manufacture and is not easy to use. The end-user must indeed burst the internal pouch within the water-filled container while avoiding to damage the container itself.

It would therefore be of great interest to provide a self-rehydrating container having an osmotically active compartment and at least a separate watertight compartment containing a solute, a liquid, a drug, nutritional materials, insoluble materials, etc. (generally a water-soluble or suspendible product) and which could be easily manufactured and especially easily used.

In the present description, osmotically active compartment means a compartment having at least a portion of its walls of semi-permeable material, such that when an osmotically active solute is retained within this compartment and when the compartment is placed into water, osmosis can take place.

### DESCRIPTION OF THE INVENTION

It is therefore a first object of the present invention to provide a self-rehydrating container for the production (by osmotically driven filtration) of oral rehydration solutions, of nutritional solutions or suspension, of solutions for medical purpose (for i.v., oral, topic, peritoneal administration). Another object of the present invention is to provide a self-rehydrating container allowing the preparation of accurately dosed solutions. Yet another object of the invention is to provide a self-rehydrating container for the preparation of solutions comprising labile materials or low molecular weight materials, these solutions being substantially free of micro-organisms coming from the outside water. A further aim of the present invention is also to provide a self-rehydrating container for the production of nutritional solutions or suspension substantially free of undesirable micro-organisms having grown within the container.

Another object of this invention is to provide a self-rehydrating container which fulfils these requirements but which is also easy to use and easy to manufacture.

The inventors have discovered that all these requirements may be fulfilled ,with a self-rehydrating container having certain structural characteristics.

That is why the invention is firstly concerned with a self-rehydrating container for the production of solutions or suspensions substantially free of undesirable micro-organisms, characterised in that the container is divided into at least two compartments by at least a non-permanent seal bonding the opposite walls of said container, the walls of the container surrounding at least a first compartment being watertight, the walls of the container surrounding at least one portion of at least a second compartment being semi-permeable, an osmotically active solute being retained in said second compartment and a solute, a drug, a nutritional suspension or powder to be put into solution or suspension is retained in said first watertight compartment.

In the present specification, a non-permanent seal means a seal which may be peeled or broken by seal anchorage failure or external manipulation or by the effect of water pressure. In a particular embodiment, the container is constituted of a rectangular sheet of semi-permeable material folded over itself to form a tube, a waterproof longitudinal seal bonding the overlapping portions of said tube, said tube being flattened and closure means closing the top and bottom extremities of the tube. The semi-permeable material constituting the membrane can be selected from a wide variety of materials including cellulose, regenerated cellulose (CELLOPHANE®, cuprammonium cellulose, . . . ), benzoylated cellulose, and collagen.

The preferred material is regenerated cellulose. This membrane may be produced by one or several known manufacturing methods, such as xanthate, cuprammonium, carbamate or organic solvent (e.g. NMMO) processes when a regenerated cellulose material is used. As disclosed in our copending application, this membrane may serve as a support layer for a thin second layer.

The second layer can be composed of cellulose derivatives (e.g. ethers, esters, nitro-cellulose, etc.), synthetic organic polymers (e.g. polyacrylic ester, polyvinyl acetate copolymers, polyurethanes, aliphatic polyamides such as a nylon 6, nylon 6.6, nylon 4.6 and the like), modified or unmodified naturally occurring polymers (e.g. starches, proteins, etc.).

Preferably, the second layer consists of a thin layer of an hydrophilic polyurethane such as those conventionally used for covering textile with a protective waterproof but water vapour permeable coating.

Preferably, the overall thickness of the membrane is from 20 to 50 μm.

To form an inner non-permanent seal dividing out the inner space of the container into two compartments, the sheet of semi permeable material advantageously possesses a strip of adhesive material coated therein in a direction perpendicular to the axis of the tube to be formed. Therefore, when the tube is flattened, the opposite walls of the container possess a strip of adhesive material into register with one another and when pressure is applied, with or without heat, a seal is created between the opposite walls of the container.

Suitable material which can be used as adhesive material to form the seal bonding the opposite walls of the container are heat sealable adhesive compositions such as polyvinylidene chloride, polyethylene, thermoplastic polyurethane, ethylene-vinyl acetate copolymer, acrylic resins, and the like, alone or in admixture. Additives such as waxes may also be added to these components.

Cold sealable adhesive compositions such as natural or modified rubber, neoprene and the like are also suitable.

It has been observed that such a seal may be easily broken when water pressure is applied on it in a direction parallel to the bonded walls. Therefore, simply by inverting the container so as to have the water filled compartment (i.e. the osmotically active compartment) above the watertight compartment, it takes just a few seconds before the seal breaks down allowing the purified water to enter the watertight compartment.

The longitudinal seal closing the tube according to this embodiment may also advantageously possess some particular features.

In order to maintain the integrity of such a seal, the seal geometry itself is of importance. It is indeed necessary that the seal withstands quite high water pressure without opening. The inventors have observed that a seal between two different portions of a semi-permeable material sheet in overlap position will withstand quite high water pressure without opening. It has indeed been observed that an overlap seal resists high water pressure without opening due to the fact the adhesive shear plane no longer lays in line with the water pressure. An overlap seal according to this embodiment is a seal where, in the zone of adherence, the opposite walls of the two semi-permeable materials are positioned in a parallel relationship, both respective membrane endings pointing in the opposite direction and made adherent to one another by means of an adhesive layer in such a manner that the water pressure no longer lays in line the adhesive shear surface of the adhesive layer.

Suitable materials which can be used as adhesive material to form the longitudinal seal are heat sealable adhesive compositions such as polyvinylidene chloride, polyethylene, thermoplastic polyurethane, ethylene-vinyl acetate copolymer, acrylic resins, and the like, alone or in admixture. Additives such as waxes may also be added to these components. Cold sealable adhesive compositions such as natural or modified rubber, neoprene and the like are also suitable.

This kind of overlap seal may also be used as closure means at the top and bottom extremities of the container.

In a more particular embodiment, the closure means at the top and bottom extremities of the container are therefore constituted of waterproof seals between the opposite walls of the container.

A double folded seal according to this embodiment is a composed seal where, in the zone of adherence, the two semi-permeable sheets are positioned in a parallel relationship, both respective membrane endings pointing in the same direction, in the zone of adherence the parallel laying sheet extremities are being folded back over such that the outer surface parts of the semi-permeable material sheet are pointing to one another. The said extremities are made adherent to one another by means of an adhesive in a manner such that the water pressure which can be exerted on the longitudinal seal lays in line with the adhesive shear plane of the adhesive coating. The adhesive coating adheres the two outer surface parts of the sheet and remains unopened even under considerable water pressure in the container.

Suitable materials which can be used as adhesive material for the top and bottom seals are heat sealable adhesive compositions such as polyvinylidene chloride, polyethylene, thermoplastic polyurethane, ethylene-vinyl acetate copolymer, acrylic resins, and the like, alone or in admixture. Additives such as waxes may also be added to these components. Cold sealable adhesive compositions such as natural or modified rubber, neoprene and the like are also suitable.

In order to render watertight or airtight the walls of the first compartment, it is coated with a suitable water- or air-barrier composition for example by coating from a solution, lamination, extrusion coating or in-situ polymerisation into either or both surfaces of the membrane. Suitable materials to this end are: for the watertight only walls polyvinyl chloride copolymer with vinyl acetate or vinyl maleate and the like and for the water- and air-tight walls polyvinylidene chloride and the like.

According to the invention, a self-rehydrating container can be used to prepare a water solution of a water soluble or suspendible product having a molecular weight well below the molecular weight cut-off of the membrane.

In this case, the low molecular weight water soluble or suspendible product must be retained in the watertight compartment while an osmotically active solute (eventually the same) is retained in the osmotically active compartment. Once the container is removed from the external water, the non-permanent seal is broken and the final solution or suspension is prepared.

Another use of the a self-rehydrating container is the preparation of accurately dosed solutions of labile water soluble or suspendible product. In this case, the labile water soluble or suspendible product is retained in the watertight compartment while an osmotically active solute is retained in the osmotically active compartment. The osmotically active compartment should also possess a mark allowing to determine the volume of water in said container. Once this mark has been reached by the internal water, the container is removed from the external water, the non-permanent seal is broken and the final accurately dosed solution or suspension is prepared.

According to the present invention, a self-rehydrating container can also be used to prevent products such as vitamins, fats or drugs to be affected by oxidation or hydrolysis because they are only contacted with water (and air if the compartment is also air-tight) just before consumption after substantially sterile water has been prepared in the osmotically active compartment and the non-permanent seal is peeled (broken).

In another application, food grade rehydrated solutions or suspensions can be prepared using a container according to the invention, the shelf life thereof can be extended. Indeed. the dried food powder is kept in the watertight compartment, and is only mixed with water, just before consumption once sterile water is prepared. Deprived from water, the food powder contaminating bacteria, if any, will not proliferate. Once the solution prepared with the container is ready, it can directly be consumed or refrigerated.

A typical use of the new self-rehydrating container with a watertight and oxygen proof compartment is to protect the components of Infant Formulae Milk and High Energy Therapeutic Milks which are subjected to dialysis and oxidation and may contain dormant bacteria or bacterial spores which would proliferate to dangerous levels with time when mixed with water. Carbohydrates are used as the water soluble osmotically active solutes in the osmotically active compartment.

Another typical use of the new self-rehydrating container according to the invention is the preparation of oral rehydration solutions. In this application, the composition may be distributed into the two compartments of the container according to the invention in the following way: 38 g/l sucrose and 2.9 g/l trisodium citrate in the osmotically active compartment and 3.5 g/l sodium chloride and 1.5 g/l potassium chloride in the watertight compartment.

The container containing thus a sodium and potassium chloride mix in the watertight compartment and an osmotically active sucrose/citrate blend in the other compartment is immersed into water with a “ready-to-use” mark pointing up. The osmotically active compartment is allowed to fill by osmosis up to the ready-to-use mark while the watertight compartment floats on top of the water. Once filled, the pack is gently removed from the external water.

The container is inverted and the non-permanent seal is allowed to gently break open. The salt content is mixed with the water and an ORS solution is obtained. Then, one can either cut the top section off and feed the dehydrated person or animal by spoon or cup feeding or tear off the top seal and place the container inside a suitable container to provide support by exposing the inner surface of the membrane for drinking.

The Examples which follow illustrate the present invention.

### EXAMPLE 1

### Preparation of the Container

1.1 Membranes

1.1.1 Regenerated cellulose film

1.1.2 Composite membranes

1.1.2.1 Commercial material

1.1.2.1.1 Nitro-cellulose grade A 500 (BAYER AG)

1.1.2.1.2 Nitro-cellulose DML 30/50 (ICI)

1.1.2.2 Specially devised material

1.1.2.2.1 A solution of 85.50 g of a polyethylene glycol (PEG 2000 (INSPEC)) having a molecular weight of about 2000, 72.80 g of a poly(tetramethylene glycol) (TERATHANE 2000 (DUPONT)) having a molecular weight of about 2000, 21.24 g of ethyleneglycol and 105.46 g of 1,1′-methylenebis(4-isocyanatobenzene) in a mixture of 420 g of dimethylformamide and 65 g of methylethylketone is introduced into a 2-liter four necked round bottomed flask equipped with a mechanical stirrer, a thermometer, an air condenser, a nitrogen inlet and a dropping funnel. The mixture is heated at 90° C. while stirring and 0.15 g of tin 2-ethylhexanoate (DABCO T9 (AIR PRODUCTS)) as catalyst, is introduced. The reaction mixture is maintained at 90° C. for 2 hours and then cooled. 120 g of methylethylketone are then introduced into the reaction vessel.

1.1.2.2.2 A solution of 133.02 g of polyethylene glycol (PEG 600 (HOECHST)) having a molecular weight of about 600 and 79.00 g of 1,1′-methylenebis(4-isocyanatocyclohexane) in 342.00 g of toluene is introduced into a 2-liter four necked round bottomed flask equipped with a mechanical stirrer, a thermometer, an air condenser, a nitrogen inlet and a dropping funnel. The mixture is heated at 90° C. while stirring and 25 mg of dibutyltinlaurate (DABCO T12 (AIR PRODUCTS)), as catalyst, is introduced. The reaction mixture is maintained at 90° C. for 6 hours and then cooled.

A solution of 13.68 g of isophorone diamine in 350.00 g of isopropyl alcohol is introduced in a second 2-liter four necked round bottomed flask equipped with a mechanical stirrer, a thermometer, an air condenser, a nitrogen inlet and a dropping funnel.

The content of the first flask is cooled at room temperature and is then added slowly to the mixture alcohol/amine (second flask). Chain extension is complete after about 3 hours.

44.2 g or fumed silica (TS100 DEGUSA) and 50 g of toluene are added to the mixture.

1.1.2.2.3 A solution of 114.40 g of polyethylene glycol having a molecular weight of about 400 (PEG 400 (HOESCHT)), 20.60 g of poly(tetramethylene glycol) having a molecular weight of about 1000 (TERATHANE 1000 (DUPONT)) and 106.80 g of 1,1′-methylenebis(4-isocyanatocyclohexane) in 342.00 g of toluene is introduced into a 2-liter four necked round bottomed flask equipped with a mechanical stirrer, a thermometer, an air condenser, a nitrogen inlet and a dropping funnel. The rest of the process is as in example 1.2.2 but the isopropyl alcohol is replaced with ethyl alcohol, the isophorone diamine is replaced with a mixture of 11.35 g of isophorone diamine and 7.12 g of an aqueous solution of hydrazine (15% (w)) and the toluene is replaced with ethyl acetate.

1.2 Seals

Polyvinylidene chloride (VICLAN VR 545 from ZENECA)

Polyvinylidene chloride (IXAN PNE 613 from SOLVAY)

1.3 Watertight coating

Polyvinylidene chloride.

1.4 Container

1.4.0 Containers without any seal dividing the inner space into two compartments has been prepared by way of comparison.

1.4.1. Containers according to the invention with a non-permanent seal.

### EXAMPLE 2

### Use of a Self-rehydrating Container

2.1 A solid composition comprising sucrose (27 g), trisodium citrate (1.7 g), sodium chloride (14 g) and potassium chloride (6 g) is retained in the unique compartment of the container prepared at point 1.4.0, and the container is placed in a vessel containing 4 liters of water. After around 9.5 hours, 496.4 ml of solution is produced which contains the equivalent of 42 g of sucrose, 3 g of trisodium citrate, 3.5 g of sodium chloride and 1.5 g of potassium chloride per litter.

Around 20% of sucrose and trisodium citrate is effectively lost through dialysis. Approximately, 88% of sodium and potassium chloride is also lost through dialysis.

2.2 A solid composition containing sucrose (27 g) and trisodium citrate (1.7 g) is placed in the osmotically active compartment of the container prepared at point 1.4.1 and sodium chloride (1.75 g) and potassium chloride (0.75 g) are retained in the watertight compartment. The container is placed into 4 liters of water. After 9.5 hours, 498 ml of solution is produced which contains the equivalent of 42 g of sucrose and 3 g of trisodium citrate per litter. The watertight compartment remains intact and floats on the surface. The container is inverted and in less than 1 minute, the water enters the watertight compartment. The solution is mixed with resulting concentration of 42 g of sucrose, 3 g trisodium citrate, 3.5 g of sodium chloride and 1.5 g of potassium chloride per litter solution.

Around 20% of sucrose and trisodium citrate is effectively lost but none of the sodium and potassium chloride is lost. The final solution composition meets the specification of the WHO for Oral Rehydration Solution.

2.3 Using the container prepared at point 1.4.0, it is possible to rehydrate high energy therapeutic milks by incorporating the milk powder (38 g) within the container and placing it in 4 liters of external water. After around 8 hours, 200 g of milk solution is produced.

However, it has been discovered-that potassium iodide, potassium chloride and magnesium chloride dialysed to equilibrium gives more than 90 weight % losses, with zinc acetate and tri-potassium citrate dialysing to a lesser extent 30% and 10% losses respectively. In addition, water soluble vitamins like vitamin c, folic acid etc. are either likely to dialyse or oxidise.

Also fats present within the therapeutic milk are more prone to oxidation.

The resulting milk initially had low total viable count (TVC) for bacteria but within 1-2 hours the TVC increases to levels which become unacceptable for human consumption.

2.4 Using the container prepared at point 1.4.1 above the osmotically active compartment contains sucrose (10 g) only. The watertight compartment contains dried skim milk, fat, vitamins and minerals (32 g). The container is placed in 4 liters of water, after around 8 hours, 200 g of sterile sucrose solution is prepared. Approximately, 20% of the sugar has dialysed. At this point, the container is inverted and in less than 1 minute the water enters the watertight compartment. The milk is thoroughly mixed. By this technique all vitamins and minerals are present, little oxidation of fats or vitamins has occurred and the fresh milk is sterile and has a greatly extended shelf life.

1. Self-rehydrating container for the production of solutions or suspensions substantially free of undesirable micro-organisms, the container having opposite walls and being divided into at least a first and second compartment by a non-permanent seal bonding the opposite walls of said container, the walls of the container surrounding at least a portion of the second compartment being semi-permeable, and the first compartment being watertight and containing an osmotically active solute and a material selected from the group consisting of a solute, a drug, and a nutritional suspension or powder to be put into solution or suspension.

2. Self-rehydrating container according to claim 1, wherein the semi-permeable wall of the second compartment comprises a semi-permeable material selected from the group consisting of cellulose, regenerated cellulose, benzoylated cellulose and collagen, said material being coated or uncoated.

3. Self-rehydrating container according to claim 2, wherein the semi-permeable material comprises a first support layer of cellulose, regenerated cellulose, benzoylated cellulose and collagen and a thin second layer selected from the group consisting of cellulose derivatives, synthetic organic polymers and modified or unmodified naturally occurring polymer.

4. Self-hydrating container according to claim 3, wherein the thin second layer consists of a thin layer of hydrophilic polyurethane.

5. Self-rehydrating container according to claim 1, wherein the watertight compartment retains a water-soluble solute having a molecular weight cut-off below the molecular weight cut-off of the said semi-permeable wall.

6. Self-rehydrating container according to claim 1, wherein the first compartment includes marks indicating volume within said compartment and the watertight compartment retains an accurately dosed composition of water-soluble solute such that an accurately dosed solution is obtained when said accurately dosed composition is put into solution in water which has entered the osmotically active compartment up to a defined volume.

7. Self-rehydrating container according to claim 1, wherein the non-permanent seal consists of polyvinylidene chloride.

8. Self-rehydrating container according to claim 1, wherein the walls of the watertight compartment also have gas barrier properties.

9. Self-rehydrating container according to claim 8, wherein the coating consists of polyvinylidene chloride.

10. Self-rehydrating container according to claim 1, wherein the watertight compartment retains dried food products.

11. Self-rehydrating container according to claim 10, wherein the watertight compartment retains Infant Formula Milk powder or High Energy Therapeutic Milk powder.

12. Process for the preparation of a solution or a suspension of at least a water soluble or suspendible product, substantially free of undesirable micro-organisms, comprising the steps of:
a) including a water soluble or suspendible product in the first compartment of a self-rehydrating container of claim 1;
b) including an osmotically active solute in the second compartment of said container;
c) immersing said container in water and leaving it in water so that water passes through the semi-permeable wall of the second compartment until the purified water in the second compartment has reached a level to produce a desired concentration of water soluble or suspendible product when dissolved or mixed with the contents of the first compartment;
d) breaking the non-permanent seal;
e) allowing the first compartment to be filled with the purified water from the second compartment; and
f) optionally allowing the water soluble or suspendible product initially retained within the first compartment to be dissolved or mixed in the water to form a solution or a suspension thereof.

13. Milk product prepared according to the process of claim 12.

14. Oral rehydration solution prepared according to the process of claim 12.
